(19) United States
(12) Patent Application Publication
(10) Pub. No.: US 2024/0286642 A1
(43) Pub. Date: Aug. 29, 2024

(54) AUTOMATIC CONTROL OF VEHICLE MOVEMENT TO FACILITATE LANE-SPLITTING

(71) Applicant: PlusAI, Inc., Santa Clara, CA (US)

(72) Inventors: Robert Joseph Dingli, Cupertino, CA (US); Joseph Michael Martin, Munich (DE); Amit Kumar, Sunnyvale, CA (US)

(21) Appl. No.: 18/113,453

(22) Filed: Feb. 23, 2023

(51) Int. Cl. B60W 60/00; B60W 40/04

(52) U.S. Cl. CPC B60W 60/0015; B60W 40/04; B60W 2554/4026; B60W 2554/4049; B60W 2554/801

(57) ABSTRACT

Methods, systems, and non-transitory computer readable media are configured to perform operations comprising receiving sensor data from at least one sensor on an ego vehicle; detecting a lane-splitting vehicle approaching the ego vehicle from behind the ego vehicle based on the sensor data; and responsive to detecting the lane-splitting vehicle approaching the ego vehicle from behind the ego vehicle, controlling the ego vehicle to move laterally away from a path of the lane-splitting vehicle.

### FIELD OF THE INVENTION

The present technology relates to vehicle systems. More particularly, the present technology relates to vehicle lateral movement to facilitate lane-splitting.

### BACKGROUND

Some vehicles can have both a manual mode of navigation and an autonomous mode of navigation. For example, in an autonomous mode of navigation, which can have different levels of autonomy, motion of a vehicle can be planned and controlled. Planning and control functions in the autonomous mode of navigation rely in part on data about the vehicle and an environment in which the vehicle is traveling, including the position and movement of other vehicles and objects. In the autonomous mode of navigation, various subsystems of the vehicle can be automatically controlled. For example, lateral movement of the vehicle may be automatically planned and controlled.

### SUMMARY

Various embodiments of the present technology can include methods, systems, and non-transitory computer readable media configured to perform operations comprising receiving sensor data from at least one sensor on an ego vehicle; detecting a lane-splitting vehicle approaching the ego vehicle from behind the ego vehicle based on the sensor data; and responsive to detecting the lane-splitting vehicle approaching the ego vehicle from behind the ego vehicle, controlling the ego vehicle to move laterally away from a path of the lane-splitting vehicle.

Some embodiments comprise detecting the lane-splitting vehicle has passed the ego vehicle; and responsive to detecting the lane-splitting vehicle has passed the ego vehicle, controlling the ego vehicle to move laterally toward the path of the lane-splitting vehicle.

In some embodiments, the ego vehicle is traveling in a lane, and controlling the ego vehicle to move laterally toward the path of the lane-splitting vehicle comprises: controlling the ego vehicle to move laterally toward a center of the lane in which the ego vehicle is traveling.

In some embodiments, controlling the ego vehicle to move laterally away from the path of the lane-splitting vehicle comprises: limiting the lateral movement of the ego vehicle according to a lane constraint, wherein the lane constraint represents a maximum movement from a center of a lane in which the ego vehicle is traveling.

In some embodiments, controlling the ego vehicle to move laterally away from the path of the lane-splitting vehicle comprises: limiting the lateral movement of the ego vehicle according to a proximity constraint, wherein the proximity constraint represents a minimum lateral distance between the ego vehicle and other vehicles.

In some embodiments, controlling the ego vehicle to move laterally away from the path of the lane-splitting vehicle comprises: limiting the lateral movement of the ego vehicle according to a lateral velocity constraint, wherein the lateral velocity constraint represents a maximum lateral velocity of the ego vehicle.

In some embodiments, controlling the ego vehicle to move laterally away from the path of the lane-splitting vehicle comprises: limiting the lateral movement of the ego vehicle according to a lateral acceleration constraint, wherein the lateral acceleration constraint represents a maximum lateral acceleration of the ego vehicle.

Some embodiments comprise determining a relative velocity between the ego vehicle and the approaching lane-splitting vehicle; and determining a time for the ego vehicle to begin moving laterally away from the path of the lane-splitting vehicle based on the relative velocity between the ego vehicle and the approaching lane-splitting vehicle.

Some embodiments comprise determining whether it is safe for the lane-splitting vehicle to pass the ego vehicle while lane splitting; and responsive to determining it is safe for the lane-splitting vehicle to pass the ego vehicle while lane splitting, actuating a safe signal observable by an operator of the lane-splitting vehicle, the safe signal indicating it is safe for the lane-splitting vehicle to pass the ego vehicle while lane splitting.

Some embodiments comprise responsive to determining it is not safe for the lane-splitting vehicle to pass the ego vehicle while lane splitting, actuating an unsafe signal observable by the operator of the lane-splitting vehicle, the unsafe signal indicating it is not safe for the lane-splitting vehicle to pass the ego vehicle while lane splitting.

It should be appreciated that many other embodiments, features, applications, and variations of the present technology will be apparent from the following detailed description and from the accompanying drawings. Additional and alternative implementations of the methods, non-transitory computer readable media, systems, and structures described herein can be employed without departing from the principles of the present technology.

### BRIEF DESCRIPTION OF THE DRAWINGS

FIG. 1 illustrates an example simplified functional block diagram of a system to automatically control lateral movement of an ego vehicle to facilitate lane-splitting by a motorcyclist, according to embodiments of the present technology.

FIG. 2 illustrates an example method, according to embodiments of the present technology.

FIGS. 3-7 illustrate examples of controlled movement of an ego vehicle, according to embodiments of the present technology.

FIG. 8 illustrates an example vehicle, according to embodiments of the present technology.

FIG. 9 illustrates an example computing system, according to embodiments of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Automatic Control of Vehicle Lateral Movement to Facilitate Lane-Splitting

An autonomous system for navigation of an ego vehicle can plan and control motion for the ego vehicle. The planning and control functions of the autonomous system rely on data about the ego vehicle and an environment in which the ego vehicle is traveling, including the position and movement of other vehicles and objects. The performance of the planning and control functions can depend on such data as the state of the ego vehicle and the conditions of the environment change.

Understanding an environment in which a vehicle having an autonomous system of navigation (e.g., ego vehicle) is traveling is fundamental to planning and control functions of the vehicle. For example, a truck traveling in an environment can plan a safe route to travel in the environment based on an understanding of the environment. The understanding of the environment can involve identifying obstacles such as other vehicles, pedestrians, traffic signals, other objects, etc. A navigation and control system can, for example, control lateral motion of the ego vehicle to avoid contact with such obstacles. As an example, properly planned and executed lateral movement by an ego vehicle can help to avoid obstacles traveling in the same lane or adjacent lanes.

In many jurisdictions, it is legal for a motorcycle to split lanes. That is, during periods of congested traffic, a motorcyclist is allowed to ride a motorcycle between adjacent lanes of traffic, including passenger cars and trucks. It is good practice for vehicles to keep an eye out for lane-splitting motorcyclists approaching from behind, and move laterally within the available lane to provide space for the lane-splitting motorcyclists to pass safely. This lateral movement also provides some confirmation to the motorcyclist that the vehicle has noticed their approach and that the vehicle is driving accordingly.

Currently, vehicle interaction with an approaching motorcycle is entirely manual, and so is susceptible to human error. For example, a human driver may fail to notice an approaching lane-splitting motorcyclist. Even upon noticing an approaching lane-splitting motorcyclist, a human driver may fail to provide adequate space for safe passage of the motorcyclist.

The present technology provides approaches for an ego vehicle to automatically detect an approaching motorcyclist that is attempting to split lanes, and automatically control lateral movement of the ego vehicle to facilitate lane-splitting by the motorcyclist, where appropriate. While a lane-splitting motorcycle is described herein in various examples, the present technology applies to other lane-splitting vehicles as well, including scooters, bicycles, and any other vehicles capable of splitting lanes.

Motorcyclists often travel in pairs or groups, and may lane-split together in, for example, single file or other type of formation. While a lane-splitting vehicle is described herein as a single vehicle, the present technology applies to pairs and groups of vehicles as well. For example, a pair or a group of vehicles may be treated as a single vehicle.

An ego vehicle that a lane-splitting motorcycle is approaching may be equipped with one or more sensors. For example, the sensors may include cameras, which may operate in visible and/or non-visible spectra such as infrared and near infrared, and similar cameras. As another example, the sensors may include other types of sensors such as lidar, radar, and the like.

Sensor data generated by the sensors may be used for navigating the ego vehicle, and may be used in conjunction with various other types of data for this purpose, such as road geometry information, GPS data, and the like. These data may be processed to predict future behaviors of obstacles, plan ego vehicle trajectories, and calculate appropriate control signals to be sent to ego vehicle actuators to manage acceleration, braking, and steering functions on the ego vehicle.

The sensor data may also be used to detect an approaching lane-splitting motorcycle. For example, sensors may be positioned on the ego vehicle to monitor a gap between adjacent lanes on a road on which the ego vehicle is traveling. The sensor data provided by the sensors may be used to detect the approach of a lane-splitting motorcycle, and to track the lane-splitting motorcycle as it passes the ego vehicle. The sensor data may also be used to predict the motion of the lane-splitting motorcycle to determine the approximate time that the motorcyclist is likely to pass the ego vehicle.

While traveling in a lane of a road, an ego vehicle may detect an approaching motorcycle attempting to lane split. At a time before the approaching motorcycle reaches the ego vehicle, the ego vehicle can automatically move laterally away from the center of the lane in which the ego vehicle is traveling and away from the path of the lane-splitting motorcycle. This lateral motion may be subject to various constraints to maintain a minimum distance between the ego vehicle and other vehicles, stationary objects, road boundaries, and the like to ensure the ego vehicle remains within its lane, and away from other vehicles. After the lane-splitting motorcycle has passed, the ego vehicle can automatically return to a nominal lateral position within its lane, for example, near the center of the lane. These lateral motions of the ego vehicle may be constrained to be smooth and predictable by surrounding traffic. For example, lateral acceleration and lateral velocity of the ego vehicle can be limited.

A notification that an approaching lane-splitting motorcycle has been detected can be automatically provided to a human driver of the ego vehicle, if present. This alert may include visual cues, audible cues, or other types of cues.

The driver of the approaching lane-splitting motorcycle can be automatically notified that the ego vehicle is making room for lane splitting. For example, the notification can be display of a green light or other symbol. As one example, the symbol may be a hand with the first and middle finger extended, a symbol well-known to motorcyclists for lane-splitting. Conversely, the driver of the approaching lane-splitting motorcycle can be automatically notified that the ego vehicle cannot make room for lane splitting by, for example, displaying a red light or other symbol. These and other inventive features and related advantages of the various embodiments of the present technology are discussed in more detail herein.

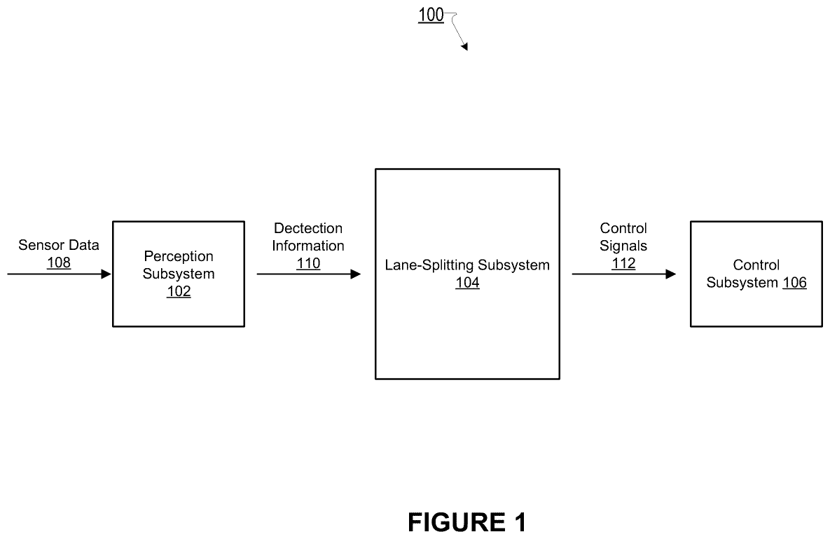

FIG. 1 illustrates an example simplified functional block diagram of a system 100 to automatically detect an approaching motorcycle that is splitting lanes, and automatically control lateral movement of an ego vehicle to facilitate lane-splitting by the motorcycle, according to embodiments of the present technology. The system 100 may include a perception subsystem 102, a lane-splitting subsystem 104, and a control subsystem 106.

In the system 100, sensor data 108 can be acquired. The sensor data 108 can be data describing an environment in which an ego vehicle is positioned. For example, the sensor data 108 can describe obstacles and their movements in the surroundings of the ego vehicle. The sensor data 108 can be data captured or collected by various types of sensors. In some embodiments, the sensors can be some or all sensors available in an advanced driver assisted system (ADAS). For example, the sensor data 108 can be provided by a camera system (e.g., based on visible light, near infrared light, infra-red light), a radar system, and a lidar system. In other examples, the sensor data 108 can be provided by a camera system alone, a radar system alone, or a lidar system alone. In some embodiments, some or all of the sensor data 108 can be captured by sensors mounted on the ego vehicle for which the system 100 is implemented. In some embodiments, a portion of the sensor data 108 can be captured by other vehicles in a fleet to which the ego vehicle belongs.

The sensor data 108 can be provided to the perception subsystem 102. The perception subsystem 102 can process and analyze the sensor data 108 to detect various types of objects (e.g., vehicles and obstacles) and their behavior in the environment of the ego vehicle. For example, one or more machine learning models can be trained to detect an approaching lane-splitting motorcycle, and to track the lane-splitting motorcycle as it passes the ego vehicle, based on the sensor data 108. In response to provision of the sensor data 108, one or more machine learning models can generate, as applicable, a probability (or likelihood) that a particular object is reflected in the sensor data 108 and a probability that the particular object is in motion. The probabilities can represent confidence levels regarding, for example, the detection of the particular object and the determination that the particular object is in motion. The detection of objects, the determinations about their possible motion, and the generation of associated confidence levels may be included in detection information 110 generated by the perception subsystem 102 and provided to the lane-splitting subsystem 104 of the system 100.

The lane-splitting subsystem 104 may generate control signals 112 based on the detection information 110. For example, when the detection information 110 indicates a motorcycle is approaching and attempting to lane split, the lane-splitting subsystem 104 may make one or more determinations, and may generate the control signals 112 based on those determinations.

One determination is that a motorcycle is approaching. Based on the determination, the lane-splitting subsystem 104 may generate a control signal 112 that causes the control subsystem 106 to alert the driver of the ego vehicle, if present. The lane-splitting subsystem 104 may determine whether safe lane-splitting by the motorcycle is possible. If not, the lane-splitting subsystem 104 may maintain its position in the lane in which the ego vehicle is traveling. In addition, the lane-splitting subsystem 104 may generate a control signal 112 that causes the control subsystem 106 to alert the motorcycle that safe lane-splitting is not possible by, for example, displaying an appropriate signal, sounding an audible alert, and the like. This control signal may also cause the control subsystem 106 to alert the driver of the ego vehicle, if present, that safe lane-splitting is not possible.

On the other hand, if the lane-splitting subsystem 104 determines that safe lane-splitting is possible, the lane-splitting subsystem 104 may generate a control signal 112 that causes the control subsystem 106 to alert the motorcycle that safe lane-splitting is possible by, for example, displaying an appropriate signal, sounding an audible alert, and the like. This control signal 112 may also cause the control subsystem 106 to alert the driver of the ego vehicle, if present, that safe lane-splitting is possible. The lane-splitting subsystem 104 may also generate control signals 112 so that the ego vehicle performs a lane-splitting procedure.

The lane-splitting procedure may include steering the ego vehicle laterally away from the path of the lane-splitting motorcycle to provide space for the lane-splitting motorcycle to pass the ego vehicle. The amount of space provided may be subject to certain constraints and rules. The ego vehicle may be constrained to maintain a minimum lateral distance from other vehicles or obstacles. For example, the minimum lateral distance can be 1.0m or any other suitable minimum distance value that is configurable based on design or preferences of a particular implementation. The ego vehicle may be constrained to a maximum lateral movement from the center of the lane in which the ego vehicle is traveling. For example, the maximum lateral distance can be 0.3m or any other suitable maximum distance value. Other types of constraints are discussed herein. The lane-splitting procedure may include tracking the lane-splitting motorcycle as it passes the ego vehicle, and causing the ego vehicle to return to the center of the lane after the lane-splitting motorcycle has passed.

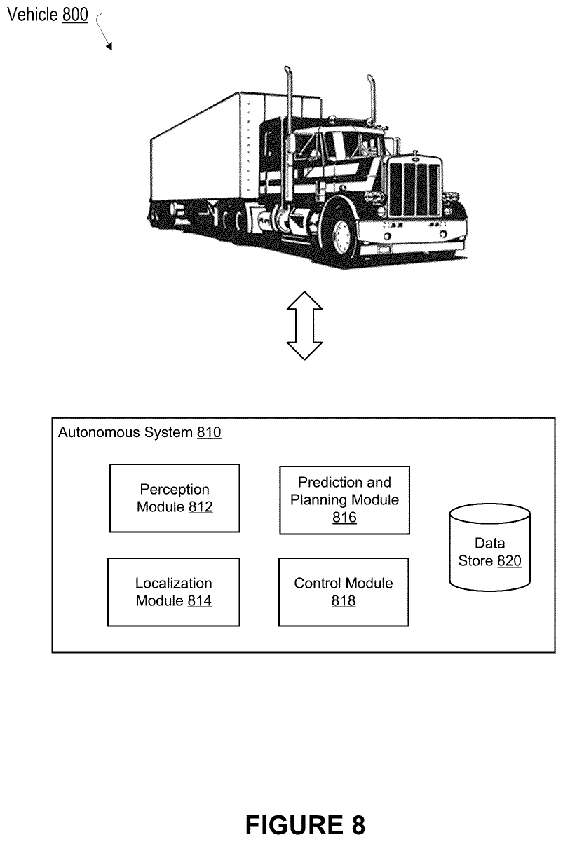

In some embodiments, the perception subsystem 102, the lane-splitting subsystem 104, and the control subsystem 106 may be implemented with a perception module 812, a prediction and planning module 816, and a control module 818 of an autonomous system 810 of FIG. 8.

In some embodiments, some or all of the functionality performed by the system 100 may be performed by one or more computing systems implemented in a vehicle. In some embodiments, some or all of the functionality performed by the system 100 may be performed by one or more backend computing systems (e.g., remote from a vehicle). In some embodiments, some or all of the functionality performed by the system 100 may be performed by one or more computing systems associated with (e.g., carried by) one or more users riding in a vehicle. In some embodiments, some or all data processed and/or stored by the system 100 can be stored in a data store (e.g., local to the system 100) or other storage system (e.g., cloud storage remote from the system 100). The components (e.g., subsystems, modules, elements, etc.) shown in this figure and all figures herein, as well as their described functionality, are exemplary only. Other implementations of the present technology may include additional, fewer, integrated, or different components and related functionality. Some components and related functionality may not be shown or described so as not to obscure relevant details. In various embodiments, one or more of the functionalities described in connection with the system 100 can be implemented in any suitable combinations. Functionalities of the system 100 or variations thereof may be further discussed herein or shown in other figures.

As referenced or suggested herein, autonomous vehicles can include, for example, a fully autonomous vehicle, a partially autonomous vehicle, a vehicle with driver assistance, or an autonomous capable vehicle. The capabilities of autonomous vehicles can be associated with a classification system or taxonomy having tiered levels of autonomy. A classification system can be specified by, for example, industry standards or governmental guidelines. For example, based on the SAE standard, the levels of autonomy can be considered using a taxonomy such as level 0 (momentary driver assistance), level 1 (driver assistance), level 2 (additional assistance), level 3 (conditional assistance), level 4 (high automation), and level 5 (full automation without any driver intervention). Following this example, an autonomous vehicle can be capable of operating, in some instances, in at least one of levels 0 through 5. According to various embodiments, an autonomous capable vehicle may refer to a vehicle that can be operated by a driver manually (that is, without the autonomous capability activated) while being capable of operating in at least one of levels 0 through 5 upon activation of an autonomous mode. As used herein, the term “driver” may refer to a local operator (e.g., an operator in the vehicle) or a remote operator (e.g., an operator physically remote from and not in the vehicle). The autonomous vehicle may operate solely at a given level (e.g., level 2 additional assistance or level 5 full automation) for at least a period of time or during the entire operating time of the autonomous vehicle. Other classification systems can provide other levels of autonomy characterized by different vehicle capabilities.

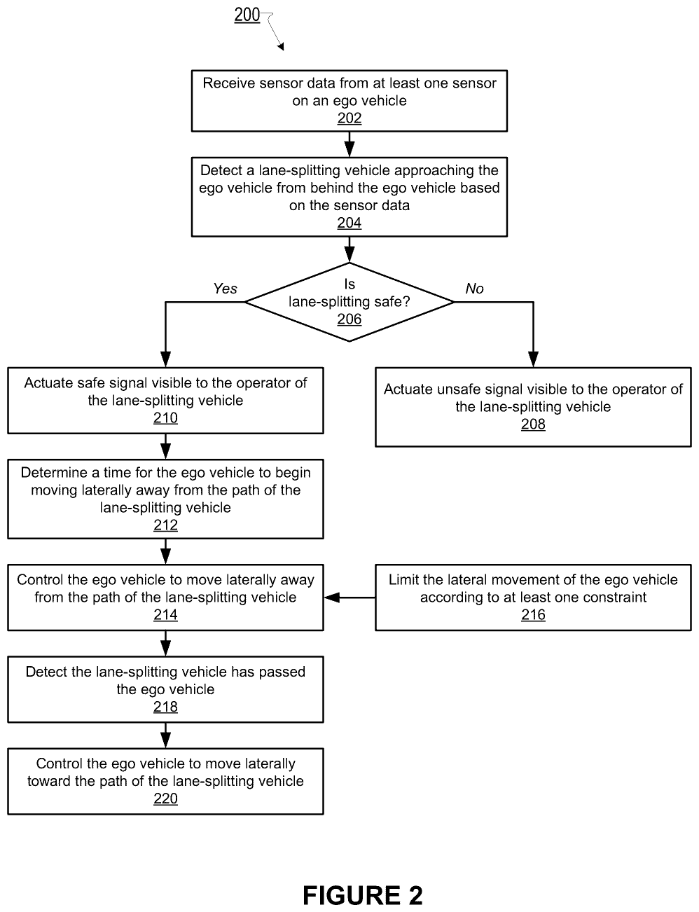

FIG. 2 illustrates an example method 200, according to embodiments of the present technology. Many variations to the example method are possible. It should be appreciated that there can be additional, fewer, or alternative steps performed in similar or alternative orders, or in parallel, within the scope of the various embodiments discussed herein unless otherwise stated.

At block 202, the method 200 may include receiving sensor data from at least one sensor on an ego vehicle. At block 204, the method 200 may include detecting a vehicle approaching the ego vehicle from behind the ego vehicle based on the sensor data. For example, the vehicle may be a motorcycle that is approaching the ego vehicle from behind. For example, the ego vehicle may be a truck. At block 206, the method 200 may include determining whether it is safe for the vehicle to pass the ego vehicle while lane splitting.

At block 208, the method 200 may include, responsive to determining it is not safe for the vehicle to pass the ego vehicle while lane splitting, actuating an unsafe signal observable by the operator of the vehicle. The unsafe signal indicates it is not safe for the vehicle to pass the ego vehicle while lane splitting. The method 200 may then return to block 202.

At block 210, the method 200 may include, responsive to determining it is safe for the vehicle to pass the ego vehicle while lane splitting, actuating a safe signal observable by an operator of the lane-splitting vehicle. The safe signal indicates it is safe for the lane-splitting vehicle to pass the ego vehicle while lane splitting.

At block 212, the method 200 may include determining a time for the ego vehicle to begin moving laterally away from the path of the lane-splitting vehicle. This process may include determining a relative velocity between the ego vehicle and the approaching lane-splitting vehicle, where the time for the ego vehicle to begin moving laterally away from the path of the lane-splitting vehicle is based on the relative velocity between the ego vehicle and the approaching lane-splitting vehicle.

At block 214, the method 200 may include controlling the ego vehicle to move laterally away from the path of the lane-splitting vehicle.

At block 216, the method 200 may include limiting the lateral movement of the ego vehicle according to at least one constraint. The constraints may include a lane constraint that represents a maximum lateral movement from the center of the lane in which the ego vehicle is traveling. The constraints may include a proximity constraint that represents a minimum lateral distance between the ego vehicle and other vehicles or obstacles. The constraints may include a lateral velocity constraint that represents a maximum lateral velocity of the ego vehicle. The constraints may include a lateral acceleration constraint that represents a maximum lateral acceleration of the ego vehicle. Other types of constraints are possible.

At block 218, the method 200 may include detecting the lane-splitting vehicle has passed the ego vehicle. At block 220, the method 200 may include, responsive to detecting the lane-splitting vehicle has passed the ego vehicle, controlling the ego vehicle to move laterally toward the path of the lane-splitting vehicle or in a manner that returns the ego vehicle to its position within the lane in which it is traveling prior to approach of the motorcycle. This process may include controlling the ego vehicle to move laterally toward the center of the lane. The method 200 may then return to block 202.

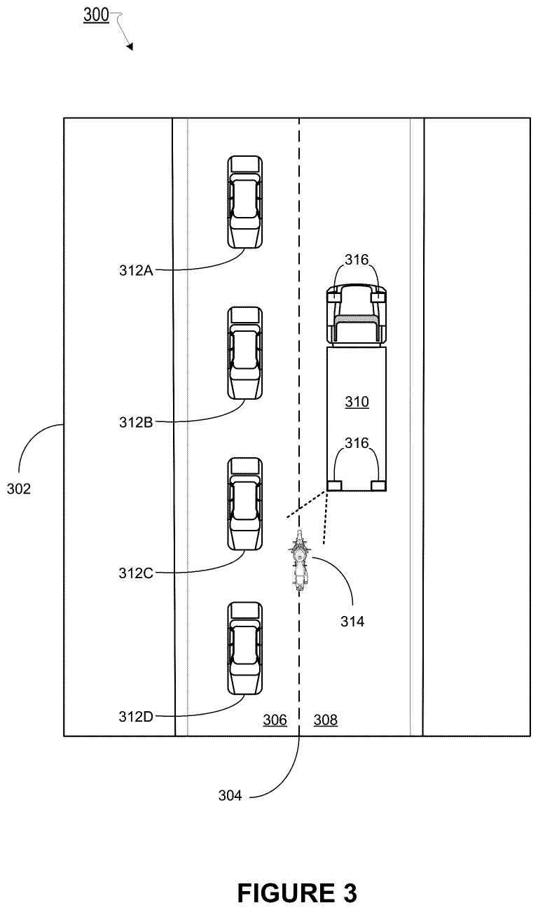

FIGS. 3-6 illustrate an example 300 of controlled movement of an ego vehicle, according to embodiments of the present technology. It should be understood that there can be additional, fewer, or alternative functionality or steps performed in similar or alternative orders, or in parallel, based on the various features and embodiments discussed herein unless otherwise stated.

As illustrated in FIG. 3, the example 300 includes a depiction 302 of a road environment. The depiction 302 includes a two-lane road having a left lane 306 and a right lane 308 separated by a lane boundary 304. Traffic in both lanes 306, 308 travels in the same direction, from the bottom of the depiction 302 towards the top. A truck 310 traveling in the right lane 308 can perform automatic control of vehicle lateral movement to facilitate lane-splitting by a motorcycle. Four cars 312A-D are travelling in the left lane 306. Traffic is moving slowly enough that a driver of a motorcycle 314 has elected to lane-split, that is, to travel between the left lane 306 and the right lane 308 along or near the lane boundary 304. The truck 310 is equipped with sensors 316, which detect the approaching lane-splitting motorcycle 314, as indicated by the dotted lines emanating from the sensors 316. The sensors 316 can be positioned or mounted at various positions of the truck 310, such as at the rear of the truck 310, at the front of the truck 310, at the sides of the truck 310, etc.

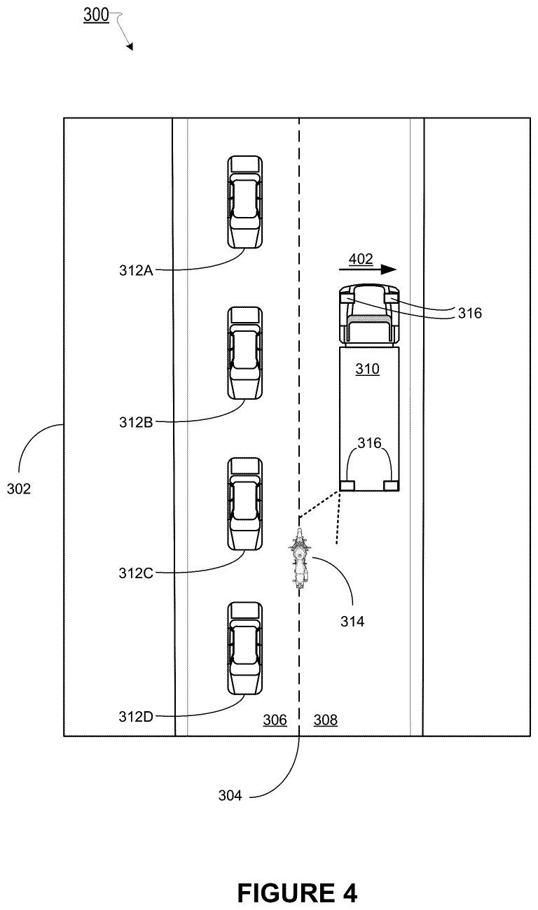

As illustrated in FIG. 4, the truck 310 responds by moving laterally away from the path of the motorcycle 314, that is, away from the lane boundary 304 along which the motorcycle 314 is traveling, as indicated by the arrow 402. Movement of the truck 310 can be subject to one or more constraints, as discussed herein.

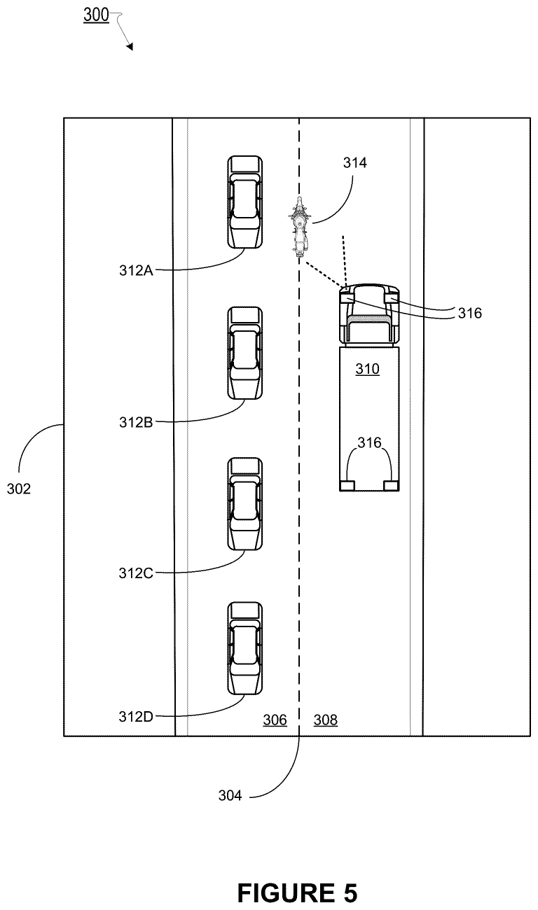

As illustrated in FIG. 5, the truck 310 monitors and tracks the lane-splitting motorcycle 314 as it passes, as indicated by the dotted lines.

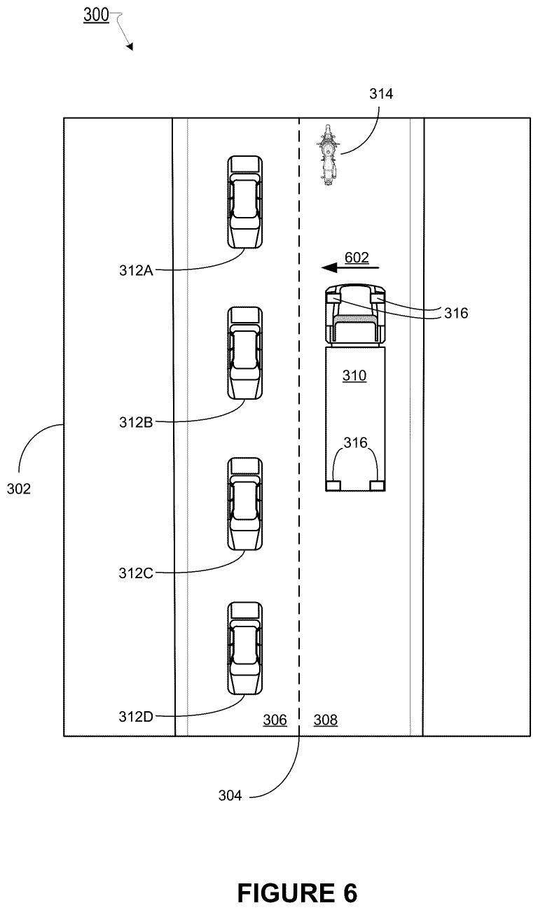

As illustrated in FIG. 6, upon determining the motorcycle 314 has passed, the truck 310, subject to applicable constraints on its motion, moves laterally toward the path of the motorcycle 314, that is, toward the lane boundary along which the motorcycle was traveling, as indicated by the arrow 602. For example, the truck 310 can return to its position within the lane prior to approach of the motorcycle 314.

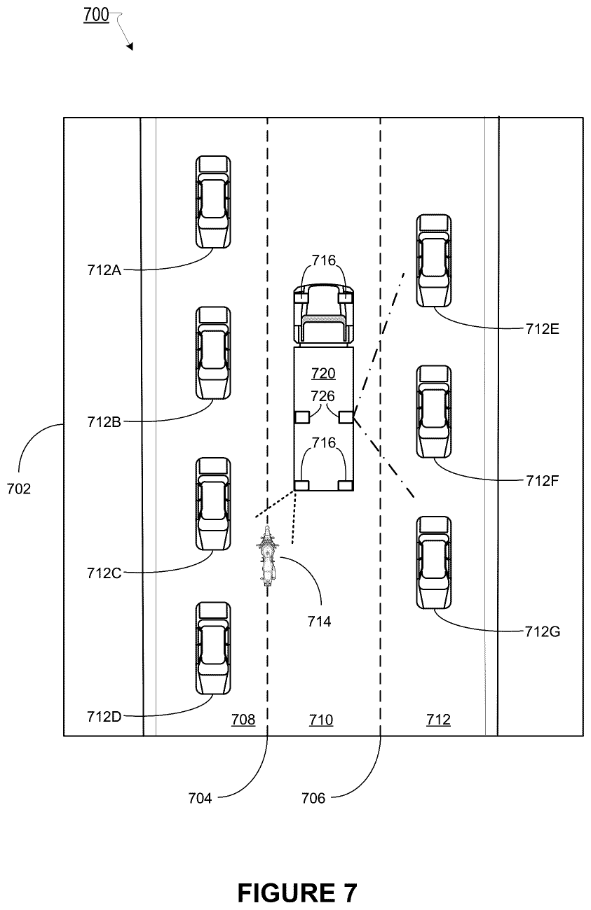

FIG. 7 illustrates an example 700 of controlled movement of an ego vehicle, according to embodiments of the present technology. It should be understood that there can be additional, fewer, or alternative functionality or steps performed in similar or alternative orders, or in parallel, based on the various features and embodiments discussed herein unless otherwise stated.

As illustrated in FIG. 7, the example 700 includes a depiction 702 of a road environment. The depiction 702 includes a three-lane road having a left lane 708, a center lane 710, and a right lane 712. The left lane 708 and the center lane 710 are separated by a lane boundary 704. The center lane 710 and the right lane 712 are separated by a lane boundary 706. Traffic in all three lanes 708, 710, 712 travels in the same direction, from the bottom of the depiction 702 towards the top. A truck 720 traveling in the center lane 710 can perform automatic control of vehicle lateral movement to facilitate lane-splitting. Four cars 712A-D are travelling in the left lane 708. In addition, three cars 712E-G are travelling in the right lane 712. Traffic is moving slowly enough that a driver of a motorcycle 714 has elected to lane-split, that is, to travel between left lane 708 and center lane 710 along the lane boundary 704 past the truck 720. The truck 720 is equipped with sensors 716, which detect the approach and passage of the lane-splitting motorcycle 714, as indicated by the dotted lines. The truck 720 is also equipped with sensors 726, which monitor the areas to the sides of the truck 720, as indicated by the broken dotted lines.

The example 700 proceeds much like the example 300 of FIGS. 3-6. Additionally, the sensors 726 provide sensor data regarding the proximity of vehicles and other obstacles to the sides of the truck 720. This sensor data can be utilized to constrain the lateral movement of the truck 720. For example, a proximity constraint that represents a minimum lateral distance between the truck 720 and other vehicles or obstacles can be applied to control motion of the truck 720. As another example, a lane constraint that represents a maximum lateral movement of the truck 720 from the center of the lane 710 and the lane boundaries 704, 706 can also be imposed to control motion of the truck 720 as it travels in the center lane 710. Therefore, when moving laterally away from the path of the motorcycle 714, the truck 720 does not cross the lane boundary 706, and moves no closer to cars 712E-F than allowed by the proximity constraint.

It is contemplated that there can be many other uses, applications, and/or variations associated with the various embodiments of the present technology. For example, various embodiments of the present technology can learn, improve, and/or be refined over time.

### Example Implementations

FIG. 8 illustrates a vehicle 800 including an autonomous system 810, according to various embodiments of the present technology. The functionality and operation of the present technology, including the autonomous system 810, can be implemented in whole or in part by the vehicle 800. The present technology can cause desired control and navigation of the vehicle 800, as described herein. In some embodiments, the vehicle 800 is a truck, which can include a trailer. The truck can be of any size (e.g., medium truck, heavy truck, very heavy truck, etc.) or weight (e.g., greater than 14,000 pounds, greater than 26,000 pounds, greater than 70,000 pounds, etc.). The autonomous system 810 of the vehicle 800 can support and execute various modes of navigation of the vehicle 800. The autonomous system 810 can support and execute an autonomous driving mode, a semi-autonomous driving mode, and a driver assisted driving mode of the vehicle 800. The autonomous system 810 also can enable a manual driving mode. For operation of the vehicle 800, the autonomous system 810 can execute or enable one or more of the autonomous driving mode, the semi-autonomous driving mode, the driver assisted driving mode, and the manual driving mode, and selectively transition among the driving modes based on a variety of factors, such as operating conditions, vehicle capabilities, and driver preferences.

In some embodiments, the autonomous system 810 can include, for example, a perception module 812, a localization module 814, a prediction and planning module 816, and a control module 818. The functionality of the perception module 812, the localization module 814, the prediction and planning module 816, and the control module 818 of the autonomous system 810 are described in brief for purposes of illustration. The components (e.g., modules, elements, etc.) shown in this figure and all figures herein, as well as their described functionality, are exemplary only. Other implementations of the present technology may include additional, fewer, integrated, or different components and related functionality. Some components and related functionality may not be shown or described so as not to obscure relevant details. In various embodiments, one or more of the functionalities described in connection with the autonomous system 810 can be implemented in any suitable combinations.

The perception module 812 can receive and analyze various types of data about an environment in which the vehicle 800 is located. Through analysis of the various types of data, the perception module 812 can perceive the environment of the vehicle 800 and provide the vehicle 800 with critical information so that planning of navigation of the vehicle 800 is safe and effective. For example, the perception module 812 can determine the pose, trajectories, size, shape, and type of obstacles in the environment of the vehicle 800. Various models, such as machine learning models, can be utilized in such determinations.

The various types of data received by the perception module 812 can be any data that is supportive of the functionality and operation of the present technology. For example, the data can be attributes of the vehicle 800, such as location, velocity, acceleration, weight, and height of the vehicle 800. As another example, the data can relate to topographical features in the environment of the vehicle 800, such as traffic lights, road signs, lane markers, landmarks, buildings, structures, trees, curbs, bodies of water, etc. As yet another example, the data can be attributes of dynamic obstacles in the surroundings of the vehicle 800, such as location, velocity, acceleration, size, type, and movement of vehicles, persons, animals, road hazards, etc.

Sensors can be utilized to capture the data. The sensors can include, for example, cameras, radar, lidar (light detection and ranging), GPS (global positioning system), IMUs (inertial measurement units), and sonar. The sensors can be appropriately positioned at various locations (e.g., front, back, sides, top, bottom) on or in the vehicle 800 to optimize the collection of data. The data also can be captured by sensors that are not mounted on or in the vehicle 800, such as data captured by another vehicle (e.g., another truck) or by non-vehicular sensors located in the environment of the vehicle 800.

The localization module 814 can determine the pose of the vehicle 800. Pose of the vehicle 800 can be determined in relation to a map of an environment in which the vehicle 800 is traveling. Based on data received by the vehicle 800, the localization module 814 can determine distances and directions of features in the environment of the vehicle 800. The localization module 814 can compare features detected in the data with features in a map (e.g., HD map) to determine the pose of the vehicle 800 in relation to the map. The features in the map can include, for example, traffic lights, crosswalks, road signs, lanes, road connections, stop lines, etc. The localization module 814 can allow the vehicle 800 to determine its location with a high level of precision that supports optimal navigation of the vehicle 800 through the environment.

The prediction and planning module 816 can plan motion of the vehicle 800 from a start location to a destination location. The prediction and planning module 816 can generate a route plan, which reflects high level objectives, such as selection of different roads to travel from the start location to the destination location. The prediction and planning module 816 also can generate a behavioral plan with more local focus. For example, a behavioral plan can relate to various actions, such as changing lanes, merging onto an exit lane, turning left, passing another vehicle, etc. In addition, the prediction and planning module 816 can generate a motion plan for the vehicle 800 that navigates the vehicle 800 in relation to the predicted location and movement of other obstacles so that collisions are avoided. The prediction and planning module 816 can perform its planning operations subject to certain constraints. The constraints can be, for example, to ensure safety, to minimize costs, and to enhance comfort.

Based on output from the prediction and planning module 816, the control module 818 can generate control signals that can be communicated to different parts of the vehicle 800 to implement planned vehicle movement. The control module 818 can provide control signals as commands to actuator subsystems of the vehicle 800 to generate desired movement. The actuator subsystems can perform various functions of the vehicle 800, such as braking, acceleration, steering, signaling, etc.

The autonomous system 810 can include a data store 820. The data store 820 can be configured to store and maintain information that supports and enables operation of the vehicle 800 and functionality of the autonomous system 810. The information can include, for example, instructions to perform the functionality of the autonomous system 810, data captured by sensors, data received from a remote computing system, parameter values reflecting vehicle states, map data, machine learning models, algorithms, vehicle operation rules and constraints, navigation plans, etc.

The autonomous system 810 of the vehicle 800 can communicate over a communications network with other computing systems to support navigation of the vehicle 800. The communications network can be any suitable network through which data can be transferred between computing systems. Communications over the communications network involving the vehicle 800 can be performed in real time (or near real time) to support navigation of the vehicle 800.

The autonomous system 810 can communicate with a remote computing system (e.g., server, server farm, peer computing system) over the communications network. The remote computing system can include an autonomous system, and perform some or all of the functionality of the autonomous system 810. In some embodiments, the functionality of the autonomous system 810 can be distributed between the vehicle 800 and the remote computing system to support navigation of the vehicle 800. For example, some functionality of the autonomous system 810 can be performed by the remote computing system and other functionality of the autonomous system 810 can be performed by the vehicle 800. In some embodiments, a fleet of vehicles including the vehicle 800 can communicate data captured by the fleet to a remote computing system controlled by a provider of fleet management services. The remote computing system in turn can aggregate and process the data captured by the fleet. The processed data can be selectively communicated to the fleet, including vehicle 800, to assist in navigation of the fleet as well as the vehicle 800 in particular. In some embodiments, the autonomous system 810 of the vehicle 800 can directly communicate with a remote computing system of another vehicle. For example, data captured by the other vehicle can be provided to the vehicle 800 to support navigation of the vehicle 800, and vice versa. The vehicle 800 and the other vehicle can be owned by the same entity in some instances. In other instances, the vehicle 800 and the other vehicle can be owned by different entities.

In various embodiments, the functionalities described herein with respect to the present technology can be implemented, in part or in whole, as software, hardware, or any combination thereof. In some cases, the functionalities described with respect to the present technology can be implemented, in part or in whole, as software running on one or more computing devices or systems. In a further example, the functionalities described with respect to the present technology can be implemented using one or more computing devices or systems that include one or more servers, such as network servers or cloud servers. It should be understood that there can be many variations or other possibilities.

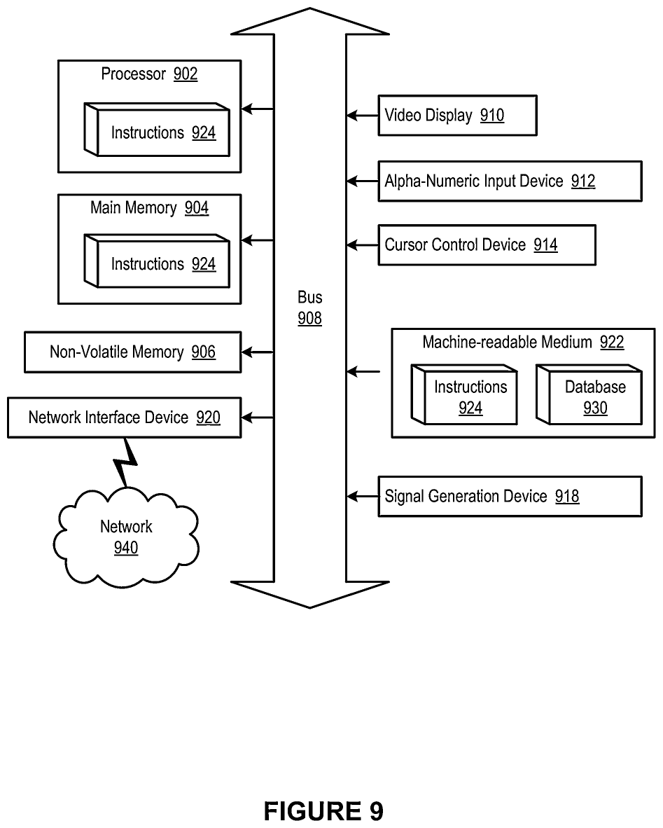

FIG. 9 illustrates an example of a computer system 900 that may be used to implement one or more of the embodiments of the present technology. The computer system 900 can be included in a wide variety of local and remote machine and computer system architectures and in a wide variety of network and computing environments that can implement the functionalities of the present technology. The computer system 900 includes sets of instructions 924 for causing the computer system 900 to perform the functionality, features, and operations discussed herein. The computer system 900 may be connected (e.g., networked) to other machines and/or computer systems. In a networked deployment, the computer system 900 may operate in the capacity of a server or a client machine in a client-server network environment, or as a peer machine in a peer-to-peer (or distributed) network environment.

The computer system 900 includes a processor 902 (e.g., a central processing unit (CPU), a graphics processing unit (GPU), or both), a main memory 904, and a non-volatile memory 906 (e.g., volatile RAM and non-volatile RAM, respectively), which communicate with each other via a bus 908. In some embodiments, the computer system 900 can be a desktop computer, a laptop computer, personal digital assistant (PDA), or mobile phone, for example. In one embodiment, the computer system 900 also includes a video display 910, an alphanumeric input device 912 (e.g., a keyboard), a cursor control device 914 (e.g., a mouse), a signal generation device 918 (e.g., a speaker) and a network interface device 920.

In one embodiment, the video display 910 includes a touch sensitive screen for user input. In one embodiment, the touch sensitive screen is used instead of a keyboard and mouse. A machine-readable medium 922 can store one or more sets of instructions 924 (e.g., software) embodying any one or more of the methodologies, functions, or operations described herein. The instructions 924 can also reside, completely or at least partially, within the main memory 904 and/or within the processor 902 during execution thereof by the computer system 900. The instructions 924 can further be transmitted or received over a network 940 via the network interface device 920. In some embodiments, the machine-readable medium 922 also includes a database 930.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 906 may also be a random access memory. The non-volatile memory 906 can be a local device coupled directly to the rest of the components in the computer system 900. A non-volatile memory that is remote from the system, such as a network storage device coupled to any of the computer systems described herein through a network interface such as a modem or Ethernet interface, can also be used.

While the machine-readable medium 922 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present technology. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 900 to perform any one or more of the processes and features described herein.

In general, routines executed to implement the embodiments of the invention can be implemented as part of an operating system or a specific application, component, program, object, module, or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 900 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine- or computer-readable media used to actually affect the distribution.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in various embodiments,” “in an example,” “in one implementation,” or the like means that a particular feature, design, structure, or characteristic described in connection with the embodiment is included in at least one embodiment of the technology. The appearances of, for example, the phrases “according to an embodiment,” “in one embodiment,” “in an embodiment,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this technology is intended to yield a patent covering numerous aspects of the invention, both independently and as an overall system, and in method, computer readable medium, and apparatus modes.

Further, each of the various elements of the invention and claims may also be achieved in a variety of manners. This technology should be understood to encompass each such variation, be it a variation of an embodiment of any apparatus (or system) embodiment, a method or process embodiment, a computer readable medium embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the technology of the embodiments of the invention is intended to be illustrative, but not limiting, of the scope of the invention, which is set forth in the following claims.

1. A computer-implemented method comprising:
receiving, by a computing system, sensor data from at least one sensor on an ego vehicle;
detecting, by the computing system, a lane-splitting vehicle approaching the ego vehicle from behind the ego vehicle based on the sensor data;
determining, by the computing system, whether safe lane splitting by the lane-splitting vehicle to pass the ego vehicle is possible;
responsive to a determination that safe lane splitting by the lane-splitting vehicle to pass the ego vehicle is possible, alerting, by the computing system, an occupant of the ego vehicle that safe lane splitting by the lane-splitting vehicle to pass the ego vehicle is possible; and
responsive to detecting the lane-splitting vehicle approaching the ego vehicle from behind the ego vehicle and to the determination that safe lane splitting is possible, controlling, by the computing system, the ego vehicle to move laterally away from a path of the lane-splitting vehicle, wherein controlling the ego vehicle to move laterally comprises limiting a lateral acceleration of the ego vehicle to a maximum allowable lateral acceleration for safety and limiting lateral movement of the ego vehicle according to a lane constraint and a proximity constraint, wherein the lane constraint represents a maximum lateral movement from a center of a lane in which the ego vehicle is traveling, and wherein the proximity constraint represents a minimum lateral distance between the ego vehicle and other vehicles.

2. The computer-implemented method of claim 1, further comprising:
detecting, by the computing system, the lane-splitting vehicle has passed the ego vehicle; and
responsive to detecting the lane-splitting vehicle has passed the ego vehicle, controlling, by the computing system, the ego vehicle to move laterally toward the path of the lane-splitting vehicle.

3. The computer-implemented method of claim 2, wherein the ego vehicle is traveling in a lane, and wherein controlling the ego vehicle to move laterally toward the path of the lane-splitting vehicle comprises:
controlling, by the computing system, the ego vehicle to move laterally toward a center of the lane in which the ego vehicle is traveling.

4. (canceled)

5. (canceled)

6. The computer-implemented method of claim 1, wherein controlling the ego vehicle to move laterally away from the path of the lane-splitting vehicle further comprises:
limiting the lateral movement of the ego vehicle according to a lateral velocity constraint, wherein the lateral velocity constraint represents a maximum lateral velocity of the ego vehicle.

7. (canceled)

8. The computer-implemented method of claim 1, further comprising:
determining, by the computing system, a relative velocity between the ego vehicle and the lane-splitting vehicle; and
determining, by the computing system, a time for the ego vehicle to begin moving laterally away from the path of the lane-splitting vehicle based on the relative velocity between the ego vehicle and the lane-splitting vehicle.

9. The computer-implemented method of claim 1, further comprising:
responsive to determining it is safe for the lane-splitting vehicle to pass the ego vehicle while lane splitting, actuating, by the computing system, a safe signal observable by an operator of the lane-splitting vehicle, the safe signal indicating it is safe for the lane-splitting vehicle to pass the ego vehicle while lane splitting.

10. The computer-implemented method of claim 1, further comprising:
responsive to determining it is not safe for the lane-splitting vehicle to pass the ego vehicle while lane splitting, actuating, by the computing system, an unsafe signal observable by an operator of the lane-splitting vehicle, the unsafe signal indicating it is not safe for the lane-splitting vehicle to pass the ego vehicle while lane splitting.

11. A system comprising:
at least one processor; and
a memory storing instructions that, when executed by the at least one processor, cause the system to perform operations comprising:
receiving sensor data from at least one sensor on an ego vehicle;
detecting a lane-splitting vehicle approaching the ego vehicle from behind the ego vehicle based on the sensor data;
determining whether safe lane splitting by the lane-splitting vehicle to pass the ego vehicle is possible;
responsive to a determination that safe lane splitting by the lane-splitting vehicle to pass the ego vehicle is possible, alerting an occupant of the ego vehicle that safe lane splitting by the lane-splitting vehicle to pass the ego vehicle is possible; and
responsive to detecting the lane-splitting vehicle approaching the ego vehicle from behind the ego vehicle and to the determination that safe lane splitting is possible, controlling the ego vehicle to move laterally away from a path of the lane-splitting vehicle, wherein controlling the ego vehicle to move laterally comprises limiting a lateral acceleration of the ego vehicle to a maximum allowable lateral acceleration for safety and limiting lateral movement of the ego vehicle according to a lane constraint and a proximity constraint, wherein the lane constraint represents a maximum lateral movement from a center of a lane in which the ego vehicle is traveling, and wherein the proximity constraint represents a minimum lateral distance between the ego vehicle and other vehicles.

12. The system of claim 11, the operations further comprising:
detecting the lane-splitting vehicle has passed the ego vehicle; and
responsive to detecting the lane-splitting vehicle has passed the ego vehicle, controlling the ego vehicle to move laterally toward the path of the lane-splitting vehicle.

13. The system of claim 12, wherein the ego vehicle is traveling in a lane, and wherein controlling the ego vehicle to move laterally toward the path of the lane-splitting vehicle comprises:
controlling the ego vehicle to move laterally toward a center of the lane in which the ego vehicle is traveling.

14. The system of claim 11, the operations further comprising:
responsive to determining it is safe for the lane-splitting vehicle to pass the ego vehicle while lane splitting, actuating a safe signal observable by an operator of the lane-splitting vehicle, the safe signal indicating it is safe for the lane-splitting vehicle to pass the ego vehicle while lane splitting.

15. The system of claim 11, the operations further comprising:
responsive to determining it is not safe for the lane-splitting vehicle to pass the ego vehicle while lane splitting, actuating an unsafe signal observable by an operator of the lane-splitting vehicle, the unsafe signal indicating it is not safe for the lane-splitting vehicle to pass the ego vehicle while lane splitting.

16. A non-transitory computer-readable storage medium including instructions that, when executed by at least one processor of a computing system, cause the computing system to perform operations comprising:
receiving sensor data from at least one sensor on an ego vehicle;
detecting a lane-splitting vehicle approaching the ego vehicle from behind the ego vehicle based on the sensor data;
determining whether safe lane splitting by the lane-splitting vehicle to pass the ego vehicle is possible;
responsive to a determination that safe lane splitting by the lane-splitting vehicle to pass the ego vehicle is possible and to the determination that safe lane splitting is possible, alerting an occupant of the ego vehicle that safe lane splitting by the lane-splitting vehicle to pass the ego vehicle is possible; and
responsive to detecting the lane-splitting vehicle approaching the ego vehicle from behind the ego vehicle and to the determination that safe lane splitting is possible, controlling the ego vehicle to move laterally away from a path of the lane-splitting vehicle, wherein controlling the ego vehicle to move laterally comprises limiting a lateral acceleration of the ego vehicle to a maximum allowable lateral acceleration for safety and limiting lateral movement of the ego vehicle according to a lane constraint and a proximity constraint, wherein the lane constraint represents a maximum lateral movement from a center of a lane in which the ego vehicle is traveling, and wherein the proximity constraint represents a minimum lateral distance between the ego vehicle and other vehicles.

17. The non-transitory computer-readable storage medium of claim 16, the operations further comprising:
detecting the lane-splitting vehicle has passed the ego vehicle; and
responsive to detecting the lane-splitting vehicle has passed the ego vehicle, controlling the ego vehicle to move laterally toward the path of the lane-splitting vehicle.

18. The non-transitory computer-readable storage medium of claim 17, wherein the ego vehicle is traveling in a lane, and wherein controlling the ego vehicle to move laterally toward the path of the lane-splitting vehicle comprises:
controlling the ego vehicle to move laterally toward a center of the lane in which the ego vehicle is traveling.

19. The non-transitory computer-readable storage medium of claim 16, the operations further comprising:
responsive to determining it is safe for the lane-splitting vehicle to pass the ego vehicle while lane splitting, actuating safe signal observable by an operator of the lane-splitting vehicle, the safe signal indicating it is safe for the lane-splitting vehicle to pass the ego vehicle while lane splitting.

20. The non-transitory computer-readable storage medium of claim 16, the operations further comprising:
responsive to determining it is not safe for the lane-splitting vehicle to pass the ego vehicle while lane splitting, actuating an unsafe signal observable by an operator of the lane-splitting vehicle, the unsafe signal indicating it is not safe for the lane-splitting vehicle to pass the ego vehicle while lane splitting.

21. The computer-implemented method of claim 1, further comprising:
providing a notification to an occupant of the ego vehicle, the notification indicating that a lane-splitting vehicle is approaching.

22. The computer-implemented method of claim 1, further comprising:
in response to a determination that lane splitting by the lane-splitting vehicle to pass the ego vehicle is not safe, navigating, by the computing system, the ego vehicle to maintain its position in a lane in which the ego vehicle is traveling.

23. The computer-implemented method of claim 1, further comprising:
tracking, by the computing system, the lane-splitting vehicle as it passes the ego vehicle.
